(19) United States
(12) Patent Application Publication
(10) Pub. No.: US 2017/0189842 A1
(43) Pub. Date: Jul. 6, 2017

(54) Filter Device

(71) Applicant: Huei-Wern Tsuei, Taipei City (TW)

(72) Inventor: Huei-Wern Tsuei, Taipei City (TW)

(21) Appl. No.: 15/215,991

(22) Filed: Jul. 21, 2016

(30) Foreign Application Priority Data
Dec. 31, 2015 (TW) 104221250

(51) Int. Cl. B01D 45/16; B04C 5/081

(52) U.S. Cl. CPC B01D 45/16; B04C 5/081

(57) ABSTRACT

A filter device is adapted to separate impurities from a fluid. The filter device has a hollow filter body being elongated and having an end that is formed with an inlet, an opposite end that is formed with an outlet, and an inner surface that extends helically from the inlet to the outlet. The filter device further has a helical channel defined by the inner surface and communicating spatially with the inlet and the outlet. When the fluid flows along the helical channel from the inlet to the outlet, the impurities are drawn to be attached to the inner surface and the filter body by a centrifugal force, thereby being separated from the fluid.

### CROSS-REFERENCE TO RELATED APPLICATION

This application claims priority of Taiwanese Patent Application No. 104221250, filed on Dec. 31, 2015.

### FIELD

The disclosure relates to a filter device, more particularly to a filter device that has a helical channel extending therethrough, and that can filter a fluid repeatedly.

### BACKGROUND

With the improvement of living standards, air cleaners are being widely used for better air quality.

Referring to FIG. 1, a conventional filter 3 is used for filtering air. In use, the conventional filter 3 is disposed to be perpendicular to an air flow direction 4. After a period of time, impurities filtered out from the air flow will accumulate on the conventional filter 3 and affect the appearance of the conventional filter 3, or even block the airflow between opposite sides of the conventional filter 3 to result in sudden pressure drop and lowering of fluid-filtering efficiency.

Moreover, Chinese Patent Publication No. 104204683 discloses another conventional filter, which is cylindrical and which has a corrugated outer surface with alternately-arranged ridges and grooves. However, since this conventional filter is also required to be disposed perpendicular to an air flow direction, an effective filtering distance is relatively short (i.e. approximately equal to the diameter of this conventional filter), and the filtering effect is limited.

### SUMMARY

Therefore, the object of the disclosure istoprovide a filter device that can filter a fluid multiple times without the appearance thereof being affected and the fluid-filtering efficiency thereof being lowered.

Accordingly, the filter device is adapted to separate impurities from the fluid. The filter device includes a hollow filter body being elongated and having an end that is formed with an inlet, an opposite end that is formed with an outlet, and an inner surface that extends helically from the inlet to the outlet. The filter further includes a helical channel defined by the inner surface, and communicating spatially with the inlet and the outlet. When the fluid flows along the helical channel from the inlet to the outlet, the impurities are trapped within the filter body or drawn to be attached to the inner surface by a centrifugal force, thereby being separated from the fluid.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional filter illustrating a surface thereof being perpendicular to an airflow direction;

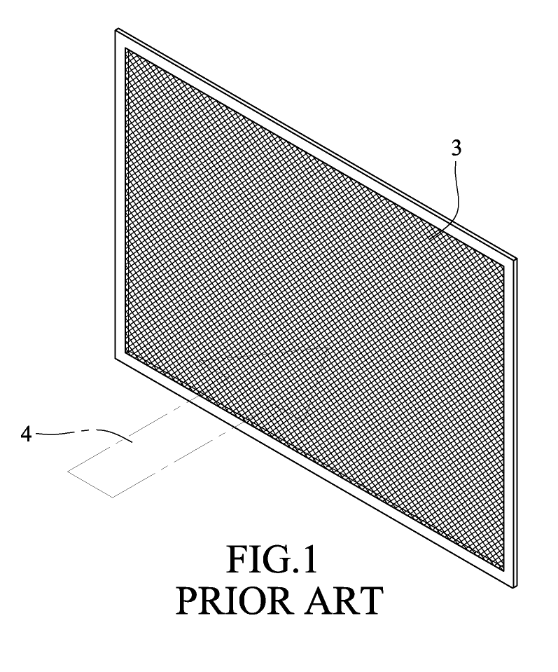

FIG. 2 is a perspective view illustrating a first embodiment of a filter device according to the disclosure;

FIG. 3 is a perspective cutaway view of the first embodiment;

FIG. 4 is a sectional view of the first embodiment taken along line IV-IV in FIG. 2;

FIG. 5 is a sectional view of a second embodiment of the filter device according to the disclosure;

FIG. 6 is a perspective partly cutaway view illustrating a third embodiment of the filter device according to the disclosure;

FIG. 7 is a perspective partly cutaway view illustrating a forth embodiment of the filter device according to the disclosure;

FIG. 8 is a perspective partly cutaway view illustrating a fifth embodiment of the filter device according to the disclosure;

FIG. 9 is a perspective partly cutaway view illustrating a sixth embodiment of the filter device according to the disclosure;

FIG. 10 is a fragmentary perspective partly cutaway view illustrating a seventh embodiment of the filter device according to the disclosure; and

FIG. 11 is a perspective view illustrating an eighth embodiment of the filter device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

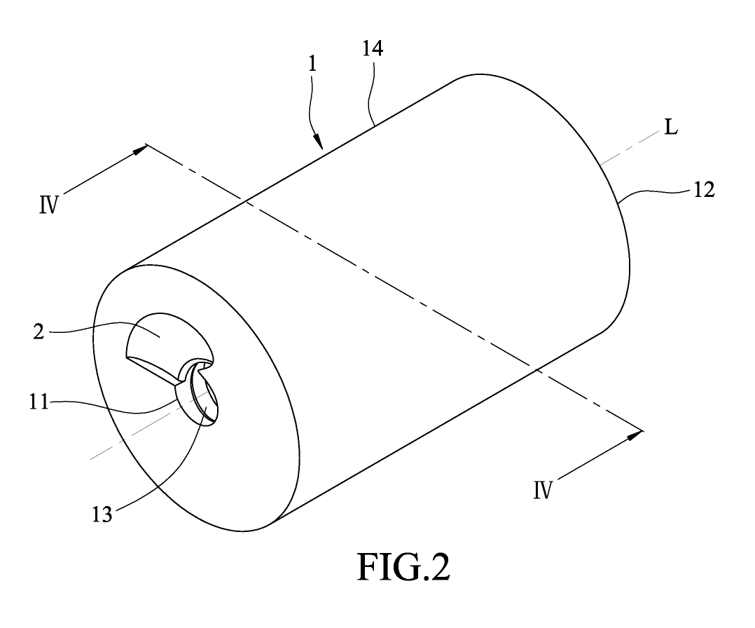

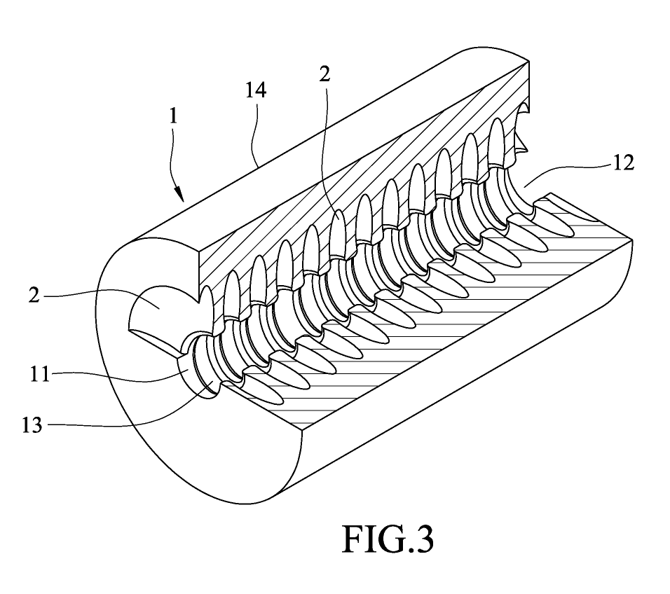

Referring to FIGS. 2, 3 and 4, a first embodiment of a filter device according to the disclosure is adapted to separate impurities 51 from a fluid 5. The filter device has a filter body 1 and a helical channel 2. In this embodiment, the fluid 5 is air, but may be water or oil in other embodiments. The number of the helical channel 2 is not limited to be one. The filter device may have two or more helical channels 2 in other embodiments.

In this embodiment, the filter body 1 is elongated, extends along its own axis (L), has a cylindrical shape, and is formed as one piece. The filter body 1 has an end that is formed with an inlet 11, an opposite end that is formed with an outlet 12, an inner surface 13 that extends helically from the inlet 11 to the outlet 12, and an outer surface 14 that is spaced apart from the inner surface 13. The helical channel 2 is defined by the inner surface 13 and communicates spatially with the inlet 11 and the outlet 12 (i.e., the filter body 1 has a hollow structure). The filter body 1 may be made of nonwoven fabric, foam plastic, activated carbon, or a composite material.

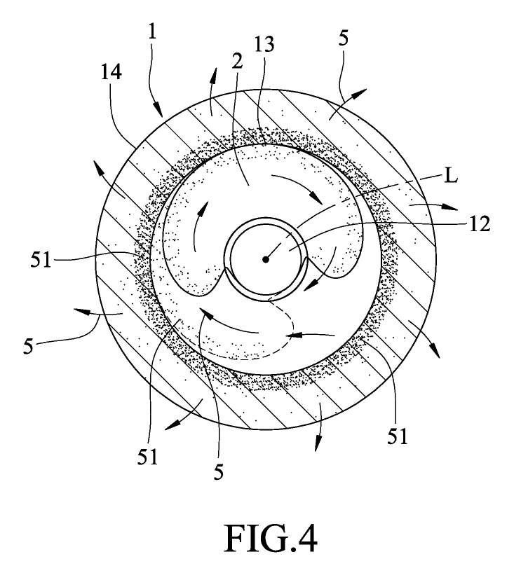

Referring to FIG. 4, after the fluid 5 flows in the filter body 1 via the inlet 1, a part of the impurities 51 is carried by a part of the fluid 5 to flow outwardly through the inner surface 13 toward the outer surface 14 (as indicated by outwardly-pointed arrows), and is eventually trapped within the filter body 1. The other part of the impurities 51 is carried by the other part of the fluid 5 to flow along the helical channel 2 (as indicated by helically-pointed arrows) toward the outlet 12, and is drawn toward the inner surface 13 by a centrifugal force. Due to the occurrence of flow separation, the other part of the impurities 51 that is close to the inner surface 13 flows in a speed which is approximately zero, and is consequently separated from the other part of the fluid 5 and attached to the inner surface 13. As a result, the impurities 51 are trapped within the filter body 1 or attached to the inner surface 13, and the filtered fluid 5 flows out of the filter body 1 through the outer surface 14 and the outlet 12. Additionally, by virtue of the helical channel 2, the fluid 5 can be filtered for multiple times as the fluid 5 flows through the multiple turns of the helical channel 2, thereby achieving a better filtering effect. Moreover, with the presence of the helical channel 2, the other part of the impurities 51 flows along with the other part of the fluid 5 through the helical channel 2 and will be filtered out without being accumulated at the outlet 12 to reduce the filtering efficiency. As such, the pressure at the inlet 11 is substantially equal to the sum of the pressure at the outlet 12 and the pressure at the outer surface 14, so that a significant pressure drop can be avoided.

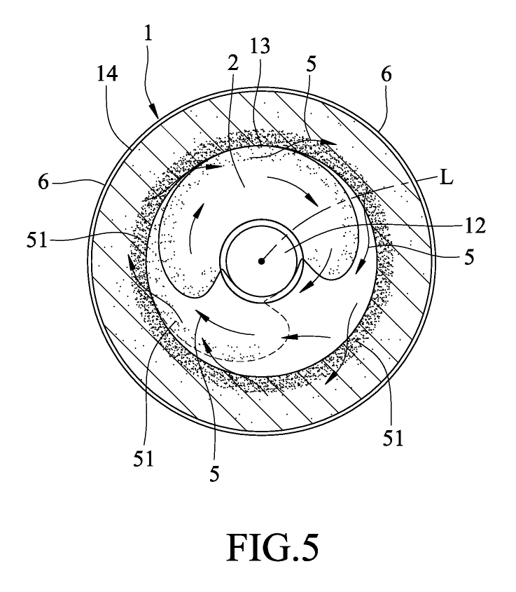

Referring to FIG. 5, a second embodiment of the filter device has a structure similar to that of the first embodiment. The main difference between the second embodiment and the first embodiment resides in that the filter body 1 further has an insulating layer 6. The insulating layer 6 is disposed on the outer surface 14. In this embodiment, the insulating layer 6 is a thin film, but is not limited thereto. The part of the fluid 5 that flows outwardly to the outer surface 14 will be blocked by the insulating layer 6 and returns to the helical channel 2 for being further filtered multiple times while flowing along the helical channel 2. It is noted that, when flowing along the helical channel 2, the impurities 51 that are larger or heavier flow slower than those that are smaller or lighter. Therefore, a front portion of the inner surface 13 that is near the inlet 11 is formed with filtering pores having a larger size and a lower distribution density. Also, the insulating layer 6 is disposed on a front portion of the outer surface 14 of the filter body 1 for blocking impurities 51 which are relatively small from permeating out of the filter body 1. Moreover, a rear portion of the inner surface 13 that is near the outlet 12 is formed with filtering pores having a smaller size and a higher distribution density for effectively filtering the smaller or lighter ones of the impurities 51. In other embodiments, the length of the insulating layer 6 may be changed according to the distribution density of the filtering pores. For example, the insulating layer 6 may cover all of the outer surface 14. While the filter body 1 is cylindrical in the first and second embodiments, it may have other configurations in other embodiments.

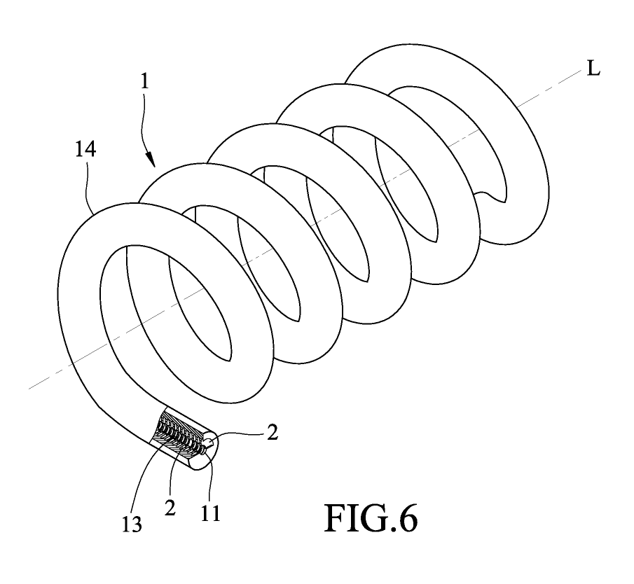

Referring to FIG. 6, a third embodiment has a structure similar to that of the first embodiment except that the filter body 1 extends helically about its own axis (L) and is formed as one piece. To be more specific, the helical channel 2 extends helically along the filter body 1 and also extends helically about the own axis (L) of the filter body 1, thereby improving the filtering efficiency. Moreover, since no impurities 51 will be accumulated on the outer surface 14 of the filter body 1, the embodiment may also be used as a decorative ornament.

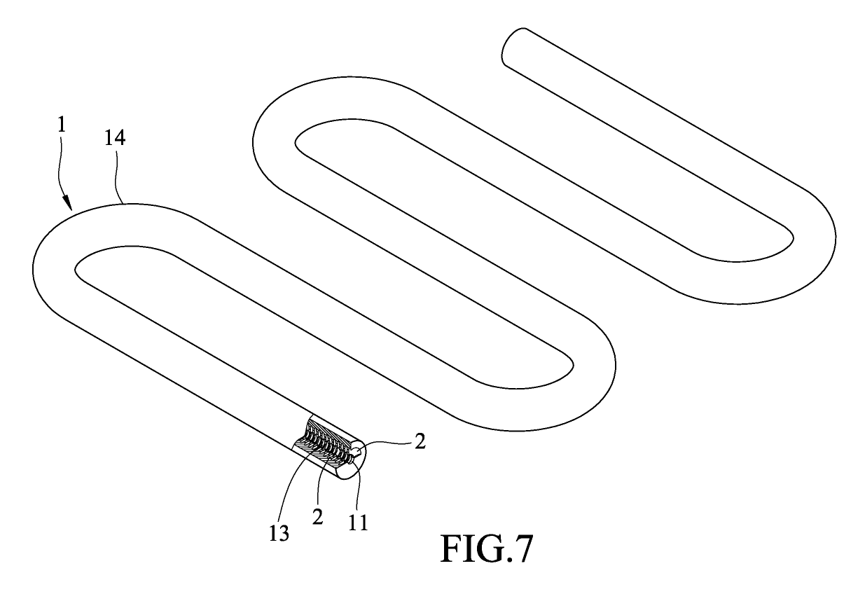

Referring to FIG. 7, a fourth embodiment has a structure similar to that of the sixth embodiment except that the filter body 1 is a continuous S-shape. The embodiment has the same advantages as those of the third embodiment.

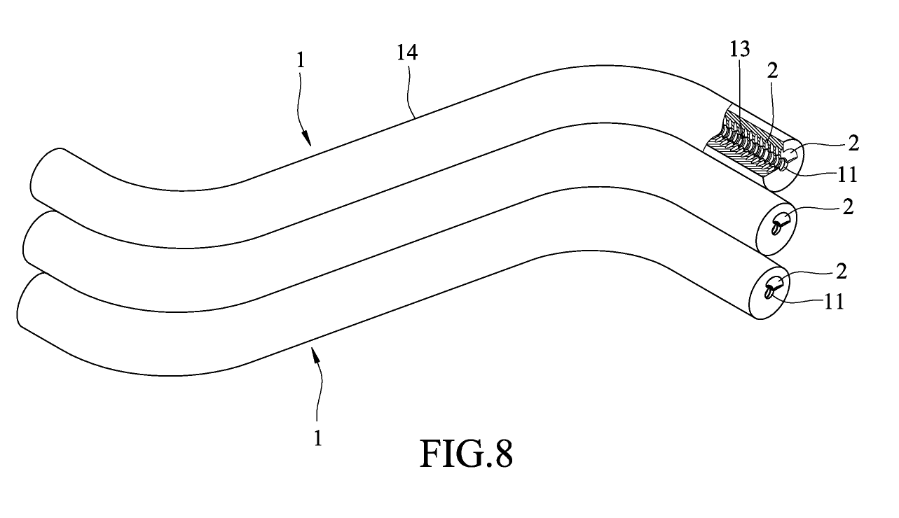

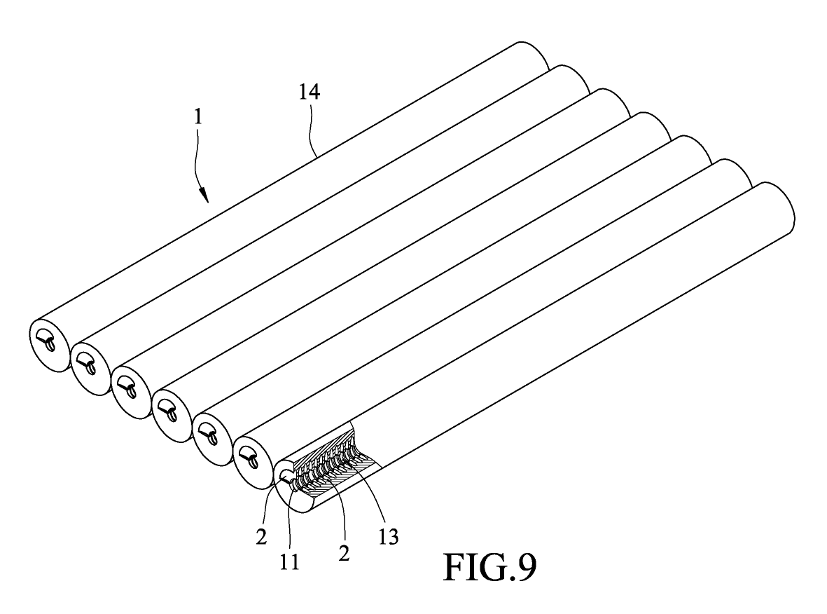

Referring to FIG. 8, a fifth embodiment is piled up by a plurality of the filter bodies 1. Each of the filter bodies 1 has a structure similar to that of the fourth embodiment, but is configured to be wave-shaped. The embodiment has the same advantages as those of the fourth embodiment. It is noted that, in the fourth and fifth embodiments, the filter body 1 is formed to be S-shaped or wave-shaped for increasing the flow distance of the impurities 51 flowing along the helical channels 2. When the flow direction changes at a turning portion of the fluid body 1, the fluid 5 exerts a pressure on the inner surface 13, so that the impurities 51 are able to more easily contact with and be trapped on the inner surface 13. Referring to FIG. 9, a sixth embodiment has a plurality of the filter bodies 1 of the first embodiment that are juxtaposed with each other for increasing the sum of the contact area between the impurities 51 and the inner surfaces 13 of the filter bodies 1. The embodiment has the same advantages as those of the fifth embodiment but has less manufacturing cost than the fifth embodiment since a straight filter body 1 is easier to make than a curved one.

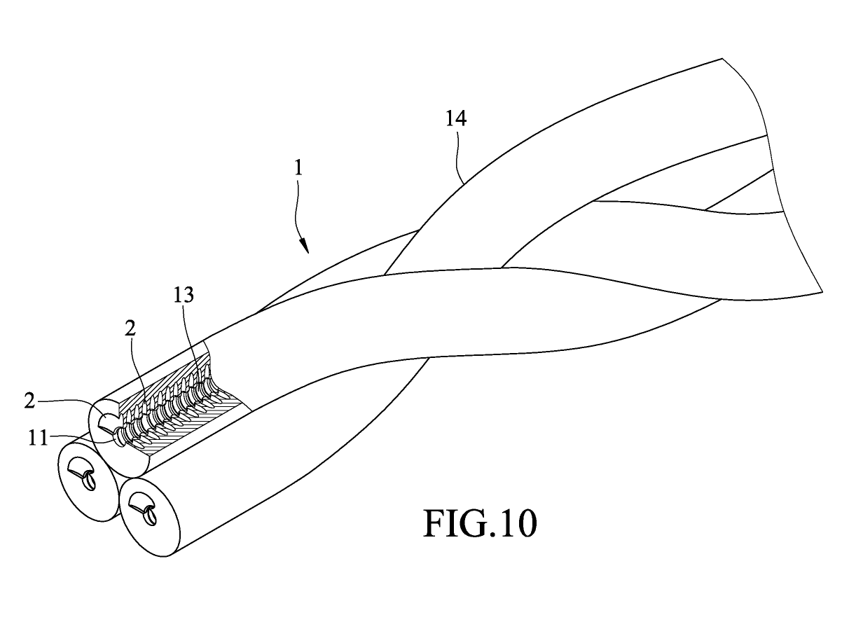

Referring to FIG. 10, a seventh embodiment has a plurality of filter bodies 1 of the first embodiment that are twisted together. The embodiment has the same advantages as those of the third embodiment.

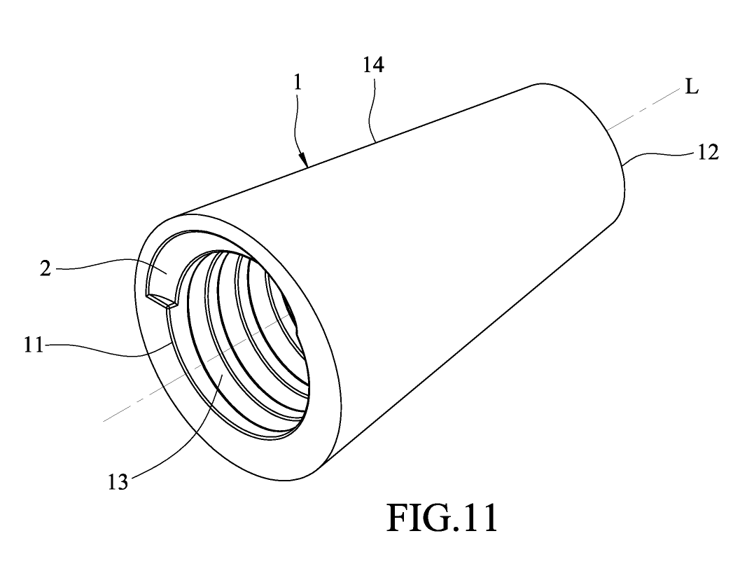

Referring to FIG. 11, an eighth embodiment has a structure similar to that of the first embodiment except that the filter body 1 has a frustoconical shape, and that the inlet 11 is larger than the outlet 12. Accordingly, the flow speed of the fluid 5 at the inlet 11 is relatively low, such that the impurities 51 tend to settle. As the helical channel 2 narrows toward the outlet 12, the flow speed of the fluid 5 increases such that the impurities 51 tend to be separated due to the occurrence of flow separation.

The shape of the filter body 1 is not limited to those described in the abovementioned embodiments.

In sum, the advantages of the filter can be summarized in the following:

1. When a part of the fluid 5 flows outwardly through the outer surface 14 of the filter body 1, a part of the impurities 51 carried therewith can be trapped in the filter body 1.

2. As another part of the fluid 5 flows through the helical channel 2, another part of the impurities 51 carried therewith can be filtered due to the occurrence of flow separation.

3. Most of the impurities 51 are retained on or inside the filter body 1 instead of being accumulated in the helical channel 2, which would otherwise causing blockage of the helical channel 2, so that the filter of the disclosure has a longer serving life.

4. By virtue of the helical shape of the helical channel 2, the impurities 51 can be effectively filtered.

5. At the front and rear portions of the filter body 1, the filtering pore has different size and distribution density for improvement of the filtering effect. With the insulating layer 6 disposed on the outer surface 14, smaller impurities 51 will not permeate out of the filter body 1. Moreover, the insulating layer 6 can also enhance the structural strength of the filter body 1.

6. The fluid 5 flows into the filter body 1 via the inlet 11 and along the helical channel 2 before exiting the filter body 1 instead of flowing transversely therethrough, so that the filter device of the disclosure, as compared to the abovementioned prior art, can filter the impurities 51 in a different but more effective way.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular future, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the interpretation so as to encompass all such modifications and equivalent arrangements.

What is claimed is:

1. A filter device adapted to separate impurities from a fluid, said filter device comprising:
a filter body being hollow, elongated and having an end that is formed with an inlet, an opposite end that is formed with an outlet, and an inner surface that extends helically from said inlet to said outlet; and
a helical channel defined by said inner surface, and communicating spatially with said inlet and said outlet;
wherein, when the fluid flows along said helical channel from said inlet to said outlet, the impurities are drawn to be attached to said inner surface by a centrifugal force, thereby being separated from the fluid.

2. The filter device as claimed in claim 1, wherein said filter body has a cylindrical shape.

3. The filter device as claimed in claim 1, wherein said filter body has a frustoconical shape, said inlet being larger than said outlet.

4. The filter device as claimed in claim 1, wherein said filter body is formed as one piece.

5. The filter device as claimed in claim 1, wherein said filter body is made of a composite material.

6. The filter device as claimed in claim 1, wherein said filter body further has:
an outer surface spaced apart from said inner surface; and
an insulating layer disposed on said outer surface.
